(19) United States
(12) Patent Application Publication
(10) Pub. No.: US 2019/0302724 A1
(43) Pub. Date: Oct. 3, 2019

(54) CONTROLLER

(71) Applicants: Kabushiki Kaisha Toshiba, Tokyo (JP); Toshiba Infrastructure Systems & Solutions Corporation, Kanagawa (JP)

(72) Inventor: Mitsuhiro SHINOHARA, Tokyo (JP)

(73) Assignees: Kabushiki Kaisha Toshiba, Tokyo (JP); Toshiba Infrastructure Systems & Solutions Corporation, Kanagawa (JP)

(21) Appl. No.: 16/332,215

(22) PCT Filed: Oct. 20, 2017
(86) PCT No.: PCT/JP2017/038015

§ 371 Date: Mar. 11, 2019

(30) Foreign Application Priority Data
Oct. 21, 2016 (JP) 2016-207220

(51) Int. Cl. G05B 19/05; G06F 15/167

(52) U.S. Cl. CPC G05B 19/054; G05B 2219/1105; G05B 19/056; G06F 15/167

(57) ABSTRACT

A controller according to an embodiment includes a memory and a processor. The processor controls an external control target device. The processor includes a controller-function core and a computer-function core. The controller-function core executes a ladder application that reads out I/O data received from the control target device from an I/O memory out of a storage area of the memory, stores a part of the I/O data out of the read I/O data in a shared memory different from the I/O memory out of the storage area, and stores control data to be transmitted to the control target device in the I/O memory. The computer-function core is a core different from the controller-function core and executes a computer application that reads out the I/O data from the shared memory.

### FIELD

Embodiments of the present invention relate to a controller.

### BACKGROUND

There is a control system that aims for improvement in processing power of an industrial control device by controlling a control target device with a plurality of control devices via an input and output device capable of inputting and outputting data with the control target device. In this control system, the plurality of control devices and the input and output device are capable of performing communication with one another via a bus.

### CITATION LIST

### Patent Literature

Patent Literature 1: Japanese Laid-open Patent Publication No. 2001-229136

### SUMMARY OF THE INVENTION

### Problem to be Solved by the Invention

Incidentally, in the above-described control system, the plurality of control devices can access data that is input and output between the input and output device and the control target device at any desired timing, and no restrictions are provided on the timing of accessing the data. Thus, the plurality of control devices access the data stored in the input and output device at individual timing, and when access to the relevant data by the plurality of control devices is performed at the same timing, collision of signals prompting the access to the data may arise.

Furthermore, in a case where the plurality of control devices perform processing on the data stored in the input and output device in accordance with an identical control program, if the timing of accessing the data by the respective control devices differs, consistency of the results may be not ensured even though the processing is performed in accordance with the identical control program. In this case, an inconvenience may arise when the plurality of control devices control the control target device in cooperation.

Moreover, in the above-described control system, when the plurality of control devices exchange data with the control target device via an identical input and output device, transfer of the data corresponding to the number of control devices is needed and the access to the input and output device increases. In particular, because accessing the input and output device often needs a longer time than accessing a memory, the accessing thereof takes time.

### Means for Solving Problem

A controller according to one embodiment includes a memory and a processor. The processor controls an external control target device. The processor includes a controller-function core and a computer-function core. The controller-function core executes a ladder application that reads out I/O data received from the control target device from an I/O memory out of a storage area of the memory, stores a part of the I/O data out of the read I/O data in a shared memory different from the I/O memory out of the storage area, and stores control data to be transmitted to the control target device in the I/O memory. The computer-function core is a core different from the controller-function core and executes a computer application that reads out the I/O data from the shared memory.

### BRIEF DESCRIPTION OF DRAWINGS

FIG. 1 is a diagram illustrating one example of a configuration of a PLC that executes a software PLC according to a first embodiment.

FIG. 2 is a diagram for explaining one example of processing of transferring control data and I/O data performed in the PLC in the first embodiment.

FIG. 3 is a diagram for explaining one example of processing of transferring control data performed in a PLC according to a second embodiment.

FIG. 4 is a diagram illustrating one example of a configuration of a PLC according to a third embodiment.

FIG. 5 is a diagram for explaining one example of processing of transferring I/O data performed in the PLC in the third embodiment.

FIG. 6 is a diagram illustrating one example of a configuration of a PLC according to a fourth embodiment.

### DETAILED DESCRIPTION

With reference to the accompanying drawings, the following describes a controller according to exemplary embodiments.

### First Embodiment

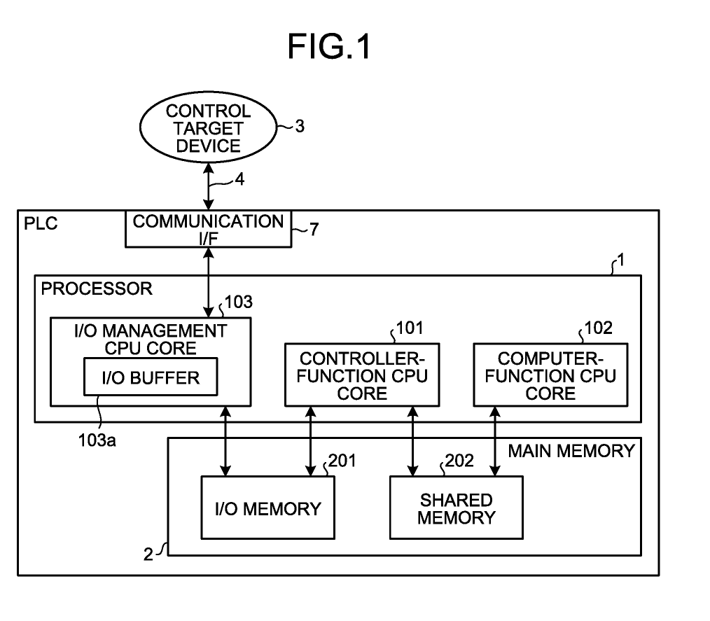

FIG. 1 is a diagram illustrating one example of a configuration of a PLC that executes a software PLC according to a first embodiment. The software programmable logic controller (PLC) according to the present embodiment is the software that controls an external control target device 3 such as a valve and a sensor. As illustrated in FIG. 1, the PLC includes a processor 1 such as a central processing unit (CPU) that has a plurality of cores, a main memory 2, and a communication I/F 7 such as a network card that enables performing communication with the control target device 3.

The main memory 2 (one example of a memory) includes an I/O memory 201 (one example of a first storage area), and a shared memory 202 (one example of a second storage area) different from the I/O memory 201. The processor 1 is a multi-core processor that includes a plurality of central processing unit (CPU) cores and controls the control target device 3 by executing software on the relevant CPU cores. Specifically, the processor 1 operates a plurality of containers isolated from one another by a single operating system (OS) executed by any one of the plurality of CPU cores. At that time, the processor 1 executes each container in different CPU cores. In the present embodiment, the processor 1 includes, as the CPU cores that execute containers, a controller-function CPU core 101, a computer-function CPU core 102, and an I/O management CPU core 103.

The I/O management CPU core 103 (one example of a first core) executes a container that includes a communication application. The communication application transfers control data to be transmitted to the control target device 3 (one example of a first control target device) and I/O data (one example of first data) received from the control target device 3, via an I/O bus 4, between the control target device 3 and the I/O memory 201. In other words, the communication application stores the I/O data in the I/O memory 201 and transmits the control data stored in the I/O memory 201 to the control target device 3. In the present embodiment, the control data includes control instructions for the control target device 3, and alarm data indicative of having detected abnormality in the I/O data. The I/O data is what is called raw data that includes a control result of the control target device 3. Furthermore, the I/O management CPU core 103 includes an I/O buffer 103a that temporarily stores therein the control data and the I/O data that are transferred between the control target device 3 and the I/O memory 201. In the present embodiment, the communication application stores and reads out the control data, the I/O data, and the like for the I/O memory 201 by using an I/O memory map stored in the main memory 2. The I/O memory map indicates an address of, out of the storage area of the I/O memory 201, an area in which the control data, the I/O data, and the like are stored.

The controller-function CPU core 101 (one example of a second core) executes a container that includes a ladder application. The ladder application is a program for performing processing in accordance with the described logic circuits and transfers the I/O data between the I/O memory 201 and the shared memory 202, for example. In other words, the ladder application reads out the I/O data from the I/O memory 201, stores in the shared memory 202 a part of the I/O data (hereinafter referred to as I/O partial data) out of the read I/O data, and further stores the control data in the I/O memory 201. In the present embodiment, the ladder application extracts, from the I/O data read out from the I/O memory 201, the I/O partial data that is needed for execution of a computer application which will be described later. As for a method of extracting the I/O partial data that is a part of the I/O data, any method may be used regardless of known methods. The ladder application then stores at least the extracted I/O partial data in the shared memory 202. For example, the ladder application extracts, out of bits included in the I/O data read out from the I/O memory 201, a part of bits needed for the execution of the computer application as the I/O partial data and stores it in the shared memory 202. In the present embodiment, the ladder application may further execute statistical processing and A/D conversion on the I/O partial data to be stored in the shared memory 202, and store it in the shared memory 202 afterward. In the present embodiment, the ladder application compares, for each piece of I/O partial data that is stored in the shared memory 202, the value indicated by the relevant I/O partial data with a predetermined threshold value and detects abnormality of the I/O partial data. Then, the ladder application, when the abnormality of the I/O partial data is detected, can also add alarm data to the I/O partial data and store it in the shared memory 202. In the present embodiment, the ladder application, by using the I/O memory map stored in the main memory 2, reads out the I/O data from the I/O memory 201 and stores the control data in the I/O memory 201. The ladder application further stores the I/O partial data in the shared memory 202 by using a shared memory map stored in the main memory 2. The shared memory map indicates an address of, out of the storage area of the shared memory 202, an area in which the I/O partial data and the like are stored. Furthermore, the ladder application that is executed by the controller-function CPU core 101 performs processing such as a data check (one example of first processing) on the I/O data to be transferred between the I/O memory 201 and the shared memory 202, that is, the I/O partial data to be stored in the shared memory 202. Accordingly, the I/O partial data stored in the shared memory 202 can be processed as normal data, and the need to perform the data check again can be eliminated in the computer-function CPU core 102 which will be described later.

The computer-function CPU core 102 (one example of a third core) executes a container that includes a computer application. For example, the computer-function CPU core 102 implements a virtual machine on the OS executed in the processor 1, executes a general-purpose OS on the virtual machine, and operates the computer application by the general-purpose OS. The computer application reads out the I/O partial data from the shared memory 202. That is, the computer application does not access the I/O data stored in the I/O memory 201. The computer application can also store the control data in the shared memory 202. In that case, the above-described ladder application reads out the control data from the shared memory 202, and stores it in the I/O memory 201 of the read control data. In the present embodiment, the computer application, by using the shared memory map stored in the main memory 2, reads out the I/O partial data from the shared memory 202 and stores the control data in the shared memory 202. Furthermore, the computer application that is executed by the computer-function CPU core 102 performs processing (one example of second processing) such as control processing of storing the control data in the shared memory 202 and display processing of displaying the I/O partial data that is stored in the shared memory 202 on a display that the controller has.

According to the above-described processing, because the I/O partial data stored in the shared memory 202 is accessed by a plurality of applications operating by a single OS, it is possible to control the timing of accessing the I/O partial data stored in the shared memory 202 by the plurality of applications and it is possible to prevent the collision of the access to the I/O partial data stored in the shared memory 202.

Furthermore, because the controller-function CPU core 101 and the computer-function CPU core 102 are able to access the I/O partial data identical to each other, when identical processing is performed on the relevant I/O partial data by the controller-function CPU core 101 and the computer-function CPU core 102, it is possible to ensure consistency of the results. In a conventional control system, each of a plurality of control devices needs to acquire the I/O data from the control target device 3 and the reception of the I/O data corresponding to the number of control devices is needed. However, because it only needs to transfer a single piece of data between the control target device 3 and the PLC, it is possible to reduce the number of times of transferring the I/O data between the control target device 3 and the PLC. Moreover, in the inside of the PLC, because only the I/O management CPU core 103 accesses the control target device 3 and the controller-function CPU core 101 and the computer-function CPU core 102 access only the data stored in the main memory 2, as compared with a case where the controller-function CPU core 101 and the computer-function CPU core 102 access the control target device 3, it is possible to shorten the time needed to access the I/O data. In addition, because the container that includes the ladder application and the container that includes the computer application are executed by the different CPU cores, even when a processing load of the computer-function CPU core 102 is varied and a delay occurs in the execution of the container that includes the computer application, the controller-function CPU 102 can execute the ladder application without being affected by the load variation.

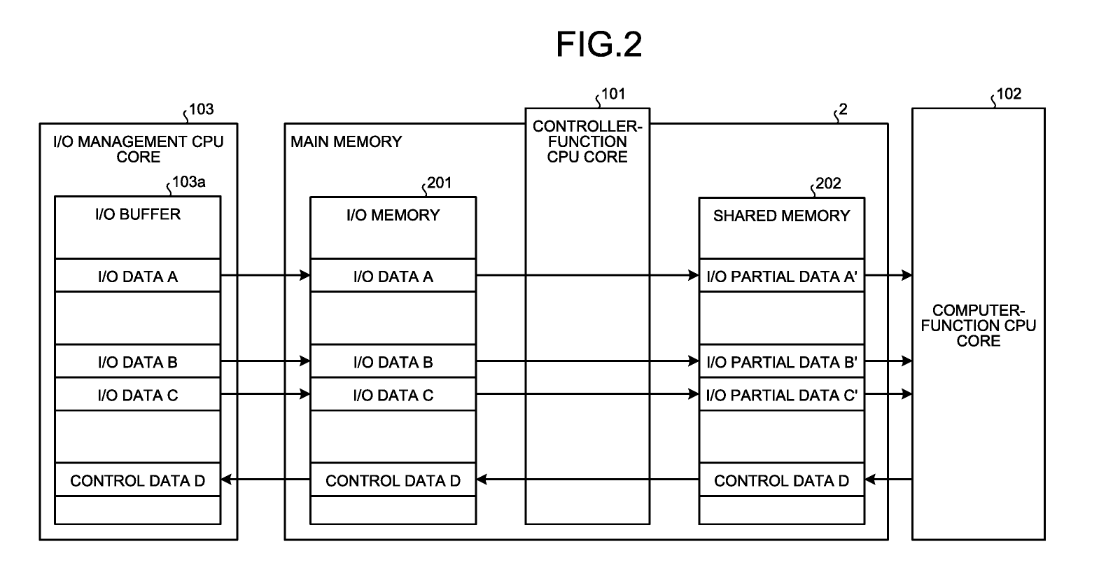

Next, with reference to FIG. 2, one example of processing of transferring control data and I/O data performed in the PLC in the present embodiment will be described. FIG. 2 is a diagram for explaining one example of the processing of transferring the control data and the I/O data performed in the PLC in the first embodiment.

As illustrated in FIG. 2, the I/O management CPU core 103 receives I/O data A, I/O data B, and I/O data C from the control target device 3 via the I/O bus 4. Then, the I/O management CPU core 103 executes the communication application, and writes the I/O data A, the I/O data B, and the I/O data C received from the control target device 3 into the I/O buffer 103a. Next, the I/O management CPU core 103 executes the communication application, and transfers (stores) the I/O data A, the I/O data B, and the I/O data C written to the I/O buffer 103a to the I/O memory 201.

As illustrated in FIG. 2, when the I/O data A, the I/O data B, and the I/O data C are written (stored) to the I/O memory 201, the controller-function CPU core 101 executes the ladder application and reads out the relevant I/O data A, the I/O data B, and the I/O data C from the I/O memory 201. Furthermore, the controller-function CPU core 101 executes the ladder application and stores a part of data of the I/O data A (hereinafter referred to as I/O partial data A′), a part of data of the I/O data B (hereinafter referred to as I/O partial data B′), and a part of data of the I/O data C (hereinafter referred to as I/O partial data C′) in the shared memory 202. At that time, the controller-function CPU core 101 executes the ladder application and transfers (stores) the I/O partial data A′, the I/O partial data B′, and the I/O partial data C′, on which the data check has been performed, to the shared memory 202.

As illustrated in FIG. 2, the computer-function CPU core 102 executes the computer application, reads out the I/O partial data A′, the I/O partial data B′, and the I/O partial data C′ from the shared memory 202, and by using the read I/O partial data A′, the I/O partial data B′, and the I/O partial data C′, executes the display processing of the I/O partial data A′, B′, and C′. The computer-function CPU core 102 further executes the computer application and writes (stores) control data D to the shared memory 202. For example, the computer-function CPU core 102 stores in the shared memory 202 as the control data D the data including a control instruction input by a user via an operating unit.

As just described, the computer-function CPU core 102 does not access the I/O data A, the I/O data B, and the I/O data C stored in the I/O memory 201. Accordingly, because the controller-function CPU core 101 and the computer-function CPU core 102 are able to perform processing on the I/O partial data A′, B′, and C′ identical to one another, when the identical processing is performed on the relevant I/O partial data A′, B′, and C′ by the controller-function CPU core 101 and the computer-function CPU core 102, it is possible to ensure consistency of the results.

In the present embodiment, because the I/O partial data A′, B′, and C′ on which the data check has been performed by the controller-function CPU core 101 are written to the shared memory 202, there is no need to perform a data check on the I/O partial data A′, B′, and C′ prior to the control processing and the display processing in the computer-function CPU core 102. Moreover, in the conventional system, because a plurality of controllers exchange I/O data with the control target device 3 via the input and output device, exchanging of the I/O data corresponding to the number of controllers is needed and the access to the control target device 3 increases. Meanwhile, in the present embodiment, because only the I/O management CPU core 103 exchanges the I/O data A, B, and C with the control target device 3, it is possible to reduce the number of times of transferring the I/O data A, B, and C between the control target device 3 and the PLC. Moreover, because the controller-function CPU core 101 and the computer-function CPU core 102 access only the data stored in the main memory 2, as compared with a case where the controller-function CPU core 101 and the computer-function CPU core 102 access the control target device 3, it is possible to shorten the time needed to access the I/O data A, B, and C.

As illustrated in FIG. 2, when the control data D is written to the shared memory 202 by the control processing in the computer-function CPU core 102, the controller-function CPU core 101 executes the ladder application, reads out the relevant control data D, and performs a data check. The controller-function CPU core 101 then executes the ladder application and writes (stores), to the I/O memory 201, the control data D on which the data check has been performed.

As illustrated in FIG. 2, when the control data D on which the data check has been performed is written to the I/O memory 201, the I/O management CPU core 103 executes the communication application, reads out the relevant control data D, and writes it to the I/O buffer 103a. Then, the I/O management CPU core 103 executes the communication application and transmits the control data D that is written to the I/O buffer 103a to the control target device 3 via the I/O bus 4.

As just described, with the PLC in the first embodiment, because the I/O partial data stored in the shared memory 202 is accessed by a plurality of applications operating by a single OS, it is possible to control the timing of accessing the I/O partial data stored in the shared memory 202 by the relevant plurality of applications and it is possible to prevent the collision of the access to the I/O partial data stored in the shared memory 202. Furthermore, because the controller-function CPU core 101 and the computer-function CPU core 102 access the I/O partial data identical to each other, when identical processing is performed on the relevant I/O partial data by the controller-function CPU core 101 and the computer-function CPU core 102, it is possible to ensure consistency of the results.

### Second Embodiment

A second embodiment is an example where the controller-function core stores control data in the shared memory instead of storing the control data in the I/O memory and where, in accordance with the control data stored in the shared memory, the computer-function CPU core executes a program that operates as a simulator of the control target device.

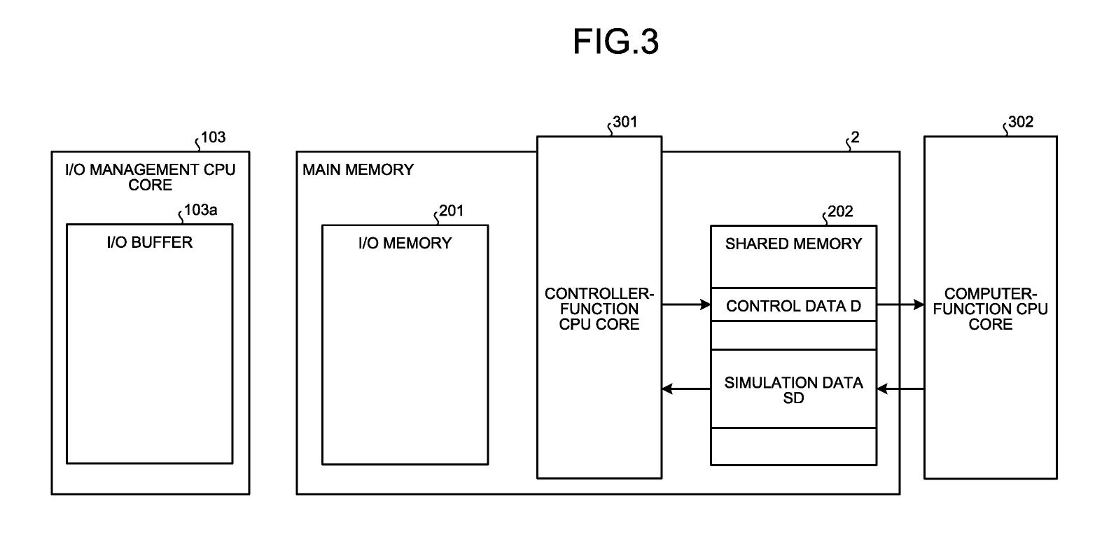

FIG. 3 is a diagram for explaining one example of processing of transferring the control data performed in a PLC according to the second embodiment. The configuration of the PLC of the second embodiment is the same as that of the PLC according to the first embodiment. In the present embodiment, when the PLC is not connected to the control target device 3, or before the control of the control target device 3 is executed, the PLC uses a computer-function CPU core 302 as a simulator of the control target device 3 in order to verify the ladder application.

Specifically, when the PLC is not connected to the control target device 3, or before the control of the control target device 3 is executed, a controller-function CPU core 301 changes into a simulation mode. Then, the controller-function CPU core 301 writes the control data D to be transferred to the control target device 3 to the shared memory 202 in place of the I/O memory 201.

The computer-function CPU core 302 executes a program (hereinafter referred to as a simulation program) that operates as a simulator of the control target device 3, in accordance with the control data D (one example of certain data) stored in the shared memory 202. Then, the computer-function CPU core 302 writes simulation data SD that is an execution result of the simulation program into the shared memory 202.

Next, the controller-function CPU core 301 reads out the simulation data SD written to the shared memory 202, and based on the execution result of the simulation program indicated by the relevant simulation data SD, determines whether the ladder application is normally executed. Accordingly, because whether the ladder application is normally executed can be determined before the control of the control target device 3 is performed, it is possible to prevent the control target device 3 from being erroneously controlled.

### Third Embodiment

A third embodiment is an example where the processor of a PLC includes an I/O memory, a controller-function CPU core, and a computer-function CPU core for each control target device. In the following description, the descriptions of the same elements as those of the above-described embodiments will be omitted.

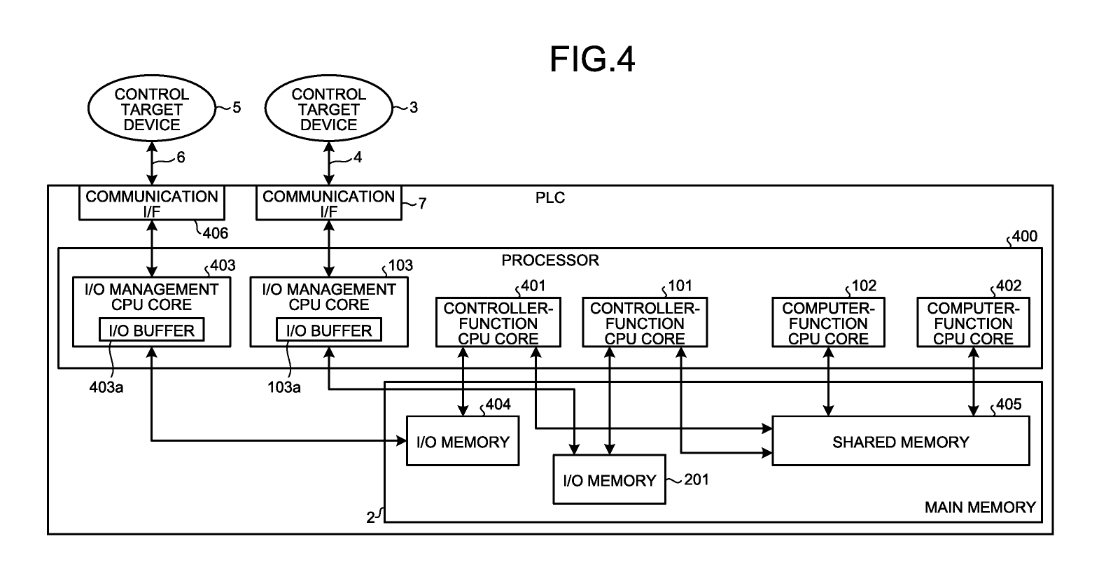

FIG. 4 is a diagram illustrating one example of a configuration of the PLC according to the third embodiment. A processor 400 of the PLC in the present embodiment includes, in addition to the controller-function CPU core 101, the computer-function CPU core 102, the I/O management CPU core 103, and the communication I/F 7, a controller-function CPU core 401 (one example of a fifth core), a computer-function CPU core 402 (one example of a sixth core), an I/O management CPU core 403 (one example of a fourth core), and a communication I/F 406 such as a network card that enables performing communication with a control target device 5. Furthermore, the main memory 7 includes, in addition to the I/O memory 201 and a shared memory 405, an I/O memory 404 (one example of a third storage area) different from the I/O memory 201 and the shared memory 405.

The I/O management CPU core 403 executes a container that includes a communication application. The communication application transfers control data and I/O data (one example of second data) between the control target device 5 (one example of a second control target device) that is different from the control target device 3 and the I/O memory 404 via an I/O bus 6. In other words, the communication application stores the I/O data received from the control target device 5 in the I/O memory 404 and transmits the control data stored in the I/O memory 404 to the control target device 5. Furthermore, the I/O management CPU core 403 includes an I/O buffer 403a that temporarily stores therein the control data and the I/O data that are transferred between the control target device 5 and the I/O memory 404.

The controller-function CPU core 401 executes a container that includes a ladder application. The ladder application transfers the I/O data between the I/O memory 404 and the shared memory 405. Specifically, the ladder application reads out the I/O data from the I/O memory 404, stores in the shared memory 202 I/O partial data that is a part of the read I/O data, and further stores the control data in the I/O memory 404. Furthermore, the ladder application that is executed by the controller-function CPU core 401 performs processing such as a data check on the I/O partial data to be transferred between the I/O memory 404 and the shared memory 405, that is, the I/O partial data to be stored in the shared memory 405.

The computer-function CPU core 402 executes a container that includes a computer application. For example, the computer-function CPU core 402, as with the computer-function CPU core 102, implements a virtual machine on the OS executed in the processor 1, executes a general-purpose OS on the virtual machine, and operates the computer application by the general-purpose OS. The computer application reads out the I/O partial data from the shared memory 405. That is, the computer applications that the computer-function CPU cores 102 and 402 execute do not access the I/O data stored in the I/O memories 201 and 404. Furthermore, the computer application that is executed in the computer-function CPU core 402 performs processing such as the control processing of storing the control data in the shared memory 405 and the processing of displaying the I/O partial data that is stored in the shared memory 405 on a display that the controller has. Accordingly, even in the case of having the I/O memory 404, the controller-function CPU core 101 or 401, the computer-function CPU core 102 or 402, and the I/O management CPU core 103 or 403 for each of the control target devices 3 and 5, because the I/O partial data stored in the shared memory 405 is accessed by a plurality of applications operating by a single OS, it is possible to control the timing of accessing the I/O partial data stored in the shared memory 405 by the relevant plurality of applications and it is possible to prevent the collision of the access to the I/O partial data stored in the shared memory 405.

Furthermore, because the controller-function CPU cores 101 and 401 and the computer-function CPU cores 102 and 402 are able to access the I/O partial data identical to one another, when identical processing is performed on the relevant I/O partial data by the controller-function CPU cores 101 and 401 and the computer-function CPU cores 102 and 402, it is possible to ensure consistency of the results. Furthermore, because it only needs to transfer a single piece of data between the control target device 3 or 5 and the PLC, it is possible to reduce the number of times of transferring the I/O data between the control target device 3 or 5 and the PLC.

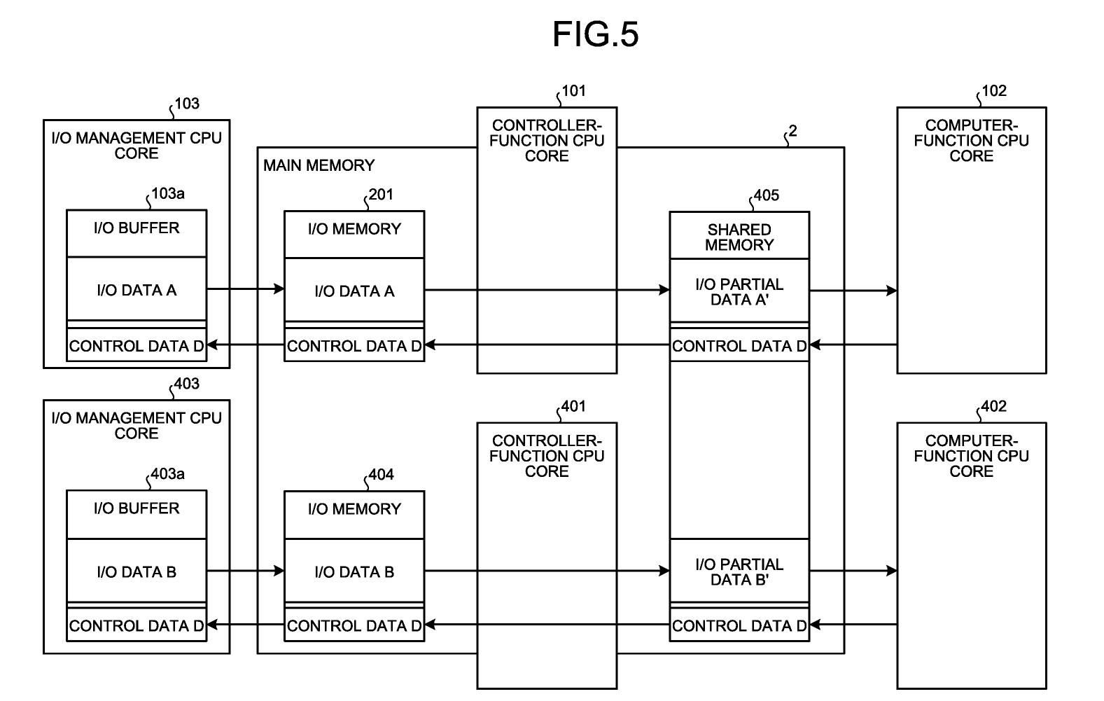

Next, with reference to FIG. 5, one example of processing of transferring the control data and the I/O data performed in the PLC according to the present embodiment will be described.

FIG. 5 is a diagram for explaining one example of the processing of transferring the control data and the I/O data performed in the PLC in the third embodiment.

As illustrated in FIG. 5, the I/O management CPU core 103 receives I/O data A from the control target device 3 via the I/O bus 4. Then, the I/O management CPU core 103 executes the communication application, and writes the I/O data A received from the control target device 3 into the I/O buffer 103a. Next, the I/O management CPU core 103 executes the communication application, and transfers (stores) the I/O data A written to the I/O buffer 103a to the I/O memory 201.

As illustrated in FIG. 5, when the I/O data A is written (stored) to the I/O memory 201, the controller-function CPU core 101 executes the ladder application and reads out the relevant I/O data A from the I/O memory 201. Moreover, the controller-function CPU 101 executes the ladder application and stores, into the shared memory 405, I/O partial data A′ that is a part of the I/O data A. At that time, the controller-function CPU core 101 executes the ladder application and transfers (stores) to the shared memory 405 the I/O partial data A′ on which the data check has been performed.

Meanwhile, as illustrated in FIG. 5, the I/O management CPU core 403 receives I/O data B from the control target device 5 via the I/O bus 6. Then, the I/O management CPU core 403 executes the communication application, and writes the I/O data B received from the control target device 5 into the I/O buffer 403a. Next, the I/O management CPU core 403 executes the communication application, and transfers (stores) the I/O data B written to the I/O buffer 403a to the I/O memory 404.

As illustrated in FIG. 5, when the I/O data B is written (stored) to the I/O memory 404, the controller-function CPU core 401 executes the ladder application and reads out the relevant I/O data B from the I/O memory 404. Moreover, the controller-function CPU core 401 executes the ladder application and stores, into the shared memory 405, I/O partial data B′ that is a part of the I/O data B. Then, the controller-function CPU core 401 executes the ladder application and transfers (stores) to the shared memory 405 the I/O partial data B′ on which the data check has been performed.

Furthermore, as illustrated in FIG. 5, the computer-function CPU cores 102 and 402 execute the computer applications, read out the I/O partial data A′ and the I/O partial data B′ from the shared memory 405, and by using the read I/O partial data A′ and the I/O partial data B′, execute the display processing of the I/O partial data A′ and B′. The computer-function CPU cores 102 and 402 further execute the computer applications and write (store) the control data D into the shared memory 405.

As just described, the computer-function CPU cores 102 and 402 do not access the I/O data A and the I/O data B stored in the I/O memory 201 or 404. Accordingly, because the controller-function CPU cores 101 and 401 and the computer-function CPU cores 102 and 402 are able to perform processing on the I/O partial data A′ and B′ identical to one another, when the identical processing is performed on the relevant I/O partial data A′ and B′ by the controller-function CPU cores 101 and 401 and the computer-function CPU cores 102 and 402, it is possible to ensure consistency of the results.

In the present embodiment, because the I/O partial data A′ and B′ on which the data check has been performed by the controller-function CPU core 101 or 401 are written to the shared memory 405, there is no need to perform the data check on the I/O partial data A′ and B′ prior to the control processing and the display processing in the computer-function CPU core 102 or 402. Moreover, in a conventional system, because a plurality of controllers exchange I/O data with the control target devices 3 and 5 via the input and output device, exchanging of the I/O data corresponding to the number of controllers is needed and the access to the control target devices 3 and 5 increases. Meanwhile, in the present embodiment, because only the I/O management CPU cores 103 and 403 exchange the I/O data A or B with the control target devices 3 and 5, it is possible to reduce the number of times of transferring the I/O data A and B between the control target devices 3 and 5 and the PLC. Moreover, because the controller-function CPU cores 101 and 401 and the computer-function CPU cores 102 and 402 access only the data stored in the main memory 2, as compared with a case where the controller-function CPU cores 101 and 401 and the computer-function CPU cores 102 and 402 access the control target devices 3 and 5, it is possible to shorten the time needed to access the I/O data A and B.

As illustrated in FIG. 5, when the control data D is written to the shared memory 405 by the control processing in the computer-function CPU core 102 or 402, the controller-function CPU core 101 executes the ladder application, reads out the relevant control data D, and performs the data check. The controller-function CPU core 101 then executes the ladder application and writes (stores), to the I/O memory 201, the control data D on which the data check has been performed.

As illustrated in FIG. 5, when the control data D on which the data check has been performed is written to the I/O memory 201, the I/O management CPU core 103 executes the communication application, reads out the relevant control data D, and writes it to the I/O buffer 103a. Then, the I/O management CPU core 103 executes the communication application and transmits the control data D that is written to the I/O buffer 103a to the control target device 3 via the I/O bus 4.

Furthermore, as illustrated in FIG. 5, when the control data D is written to the shared memory 405 by the control processing in the computer-function CPU 102 or 402, the controller-function CPU core 401 executes the ladder application, reads out the relevant control data D, and performs the data check. The controller-function CPU core 401 then executes the ladder application and writes (stores), to the I/O memory 404, the control data D on which the data check has been performed.

As illustrated in FIG. 5, when the control data D on which the data check has been performed is written to the I/O memory 404, the I/O management CPU core 403 executes the communication application, reads out the relevant control data D, and writes it to the I/O buffer 403a. Then, the I/O management CPU core 403 executes the communication application and transmits the control data D that is written to the I/O buffer 403a to the control target device 5 via the I/O bus 6.

As just described, with the PLC in the third embodiment, even in the case of having the I/O memory 201 or 404, the controller-function CPU core 101 or 401, the computer-function CPU core 102 or 402, and the I/O management CPU core 103 or 403 for each of the control target devices 3 and 5, because the I/O partial data stored in the shared memory 405 is accessed by a plurality of applications operating by a single OS, it is possible to control the timing of accessing the I/O partial data stored in the shared memory 405 by the relevant plurality of applications and it is possible to prevent the collision of the access to the I/O partial data stored in the shared memory 405. Furthermore, because the controller-function CPU cores 101 and 401 and the computer-function CPU cores 102 and 402 access the I/O partial data identical to one another, when identical processing is performed on the relevant I/O partial data by the controller-function CPU cores 101 and 401 and the computer-function CPU cores 102 and 402, it is possible to ensure consistency of the results.

In the present embodiment, the software PLC has the I/O memories 201 and 404, the controller-function CPU cores 101 and 401, the computer-function CPU cores 102 and 402, and the I/O management CPU cores 103 and 403 for each of the two control target devices 3 and 5. However, in the case where there are three or more control target devices, it is assumed that the I/O memory, the controller-function CPU core, the computer-function CPU core, and the I/O management CPU core are provided similarly for each control target device.

### Fourth Embodiment

A fourth embodiment is an example where a controller-function CPU core executes a communication application. In the following description, the descriptions of the configurations the same as those of the first embodiment will be omitted.

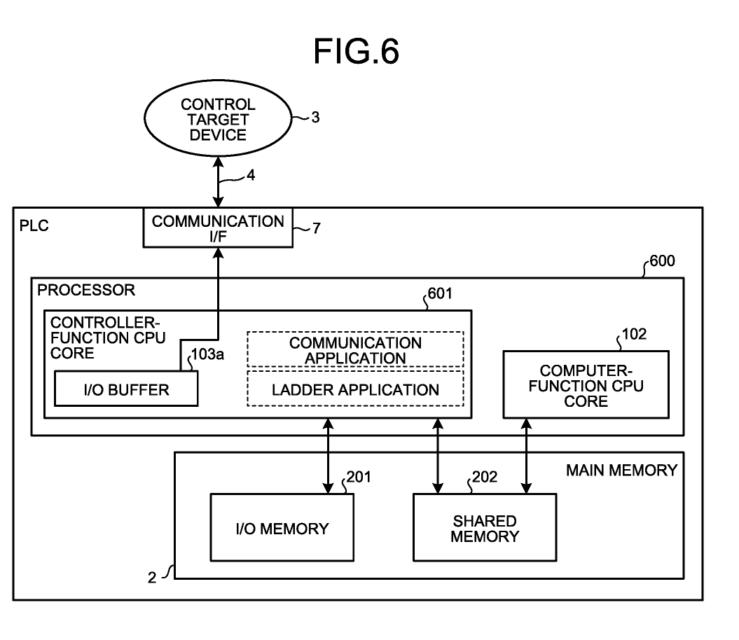

FIG. 6 is a diagram illustrating one example of a configuration of a PLC according to the fourth embodiment. The PLC in the present embodiment, as illustrated in FIG. 6, includes a processor 600, the main memory 2, and the communication I/F 7. The processor 600 includes, as the CPU cores that execute a plurality of containers, a controller-function CPU core 601 and the computer-function CPU core 102.

The controller-function CPU core 601, in place of the I/O management CPU 103 in the first embodiment, executes a container that includes a communication application. Accordingly, when a multi-core processor having at least two CPU cores is used as the processor 600, it is possible to control the control target device 3.

Thus, with the PLC in the fourth embodiment, even in the case of not having a dedicated CPU for executing the communication application, the same operation and effect as those of the above-described embodiments can be obtained.

As in the foregoing, with the first to the fourth embodiments, because the I/O partial data stored in the shared memory 202 or 405 is accessed by a plurality of applications operating by a single OS, it is possible to control the timing of accessing the I/O partial data stored in the shared memory 202 or 405 by the plurality of applications and it is possible to prevent the collision of the access to the I/O partial data stored in the shared memory 202.

While some embodiments of the present invention have been exemplified in the foregoing, those embodiments are presented as mere examples and are not intended to limit the scope of the invention. Those novel embodiments described herein may be embodied in various other forms, and without departing from the scope of the invention, various omissions, substitutions, and modifications can be made. Those embodiments and the modifications thereof are included in the scope and spirit of the invention and are included in the scope of the invention stated in the appended claims and the scope of the equivalents thereof.

What is claimed is:

1. A controller comprising:
a memory; and
a processor configured to control an external control target device, wherein
the processor includes
a controller-function core configured to execute a ladder application that reads out I/O data received from the control target device from an I/O memory out of a storage area of the memory, stores a part of the I/O data out of the read I/O data in a shared memory different from the I/O memory out of the storage area, and stores control data to be transmitted to the control target device in the I/O memory, and
a computer-function core that is a core different from the controller-function core and is configured to execute a computer application that reads out the I/O data from the shared memory.

2. The controller according to claim 1, wherein the controller-function core further executes an I/O application that performs storing the I/O data received from the control target device into the I/O memory and transmitting the control data stored in the I/O memory to the control target device.

3. The controller according to claim 1, wherein
the controller-function core stores the control data in the shared memory, and
the computer-function core further executes a program that operates as a simulator of the control target device in accordance with the control data stored in the shared memory, and stores an execution result of the program into the shared memory.

4. The controller according to claim 1, wherein the processor includes the I/O memory, the controller-function core, and the computer-function core for each control target device.
